(19) United States
(12) Patent Application Publication
(10) Pub. No.: US 2014/0121864 A1
(43) Pub. Date: May 1, 2014

(54) VEHICLE PRESENCE NOTIFICATION SYSTEM

(71) Applicant: Akiko NAKATANI, (US)

(72) Inventors: Hidenori NAKATANI, Osaka (JP); Akiko NAKATANI, Osaka (JP)

(73) Assignee: Akiko NAKATANI, Osaka (JP)

(21) Appl. No.: 13/660,100

(22) Filed: Oct. 25, 2012

(51) Int. Cl. G06F 17/00

(52) U.S. Cl. CPC G06F 17/00
USPC 701/22

(57) ABSTRACT

A presence notification system generates a notification sound around a vehicle with a quiet running sound, such as a hybrid car, an electric automobile, or a fuel-cell automobile, and notifies pedestrians of presence and approaching of the vehicle so as to be capable of heightening safety, and can maintain comfortability in the vehicle without bringing discomfort to the surrounding pedestrians and a driver and a fellow passenger in the vehicle. A contact pickup device 3 for capturing oscillation of a housing of an inverter I so as to convert the oscillation into an electric signal is mounted to the housing of the inverter I to be used in a driving circuit for driving an electric motor M. An amplifying device 5 for amplifying the electric signal output from the contact pickup device 3 is provided, and a notification sound generating device 2 for outputting a sound to a periphery of the vehicle based on the electric signal output from the amplifying device 5 is provided.

### BACKGROUND OF THE INVENTION

1. Field of the Invention

The present invention relates to a presence notification system that is provided to a vehicle which uses an electric motor as a power source and generates a notification sound around the vehicle.

2. Description of the Background Art

Since vehicles that use an electric motor as a power source such as hybrid cars, electric automobiles, or fuel-cell automobiles run quietly, pedestrians are hard to notice presence and approaching of vehicles. In order to solve the problem of the extremely quiet running sound and secure safety of pedestrians, various techniques for generating pseudo-engine sounds according to running speeds of vehicles so as to notify the surrounding pedestrians of presence of vehicles have been proposed (for example, see Japanese Unexamined Patent Application Nos. 7-32948 and 5-208636).

However, since pseudo-engine sounds are not original sounds of vehicles running via electric motors, surrounding pedestrians and a driver and a fellow passenger in a vehicle feel discomfort. When the vehicle's speed rises, the loud original sounds of the motors together with the pseudo-engine sounds increase the discomfort. It is proposed to cancel pseudo-engine sounds at predetermined speed or more. However, sounds at a low speed and at a high speed are completely different from each other, which causes discomfort and makes the driver and the fellow passenger concern about vehicle speed, thereby deteriorating comfortability.

Therefore, in view of the above situation, in order to solve it, the present invention provides a presence notification system that generates a notification sound around a vehicle with a quiet running sound such as a hybrid car, an electric automobile, or a fuel-cell automobile so as to notify pedestrians of presence or approaching of a vehicle to heighten safety, and does not provide discomfort to surrounding pedestrians and a driver and a fellow passenger in the vehicle and maintains comfortability in the vehicle.

### SUMMARY OF THE INVENTION

In order to solve the above problem, the present invention provides a presence notification system provided to a vehicle having an electric motor as a power source and using an inverter in a driving circuit for driving the electric motor that includes a contact pickup device that is provided to a housing of the inverter and captures oscillation of the housing and converts the oscillation into an electric signal, an amplifying device for amplifying the electric signal output from the contact pickup device, and a notification sound generating device for outputting a sound to a periphery of the vehicle based on the electric signal output from the amplifying device.

It is preferable that a control unit for controlling an operation of the amplifying device based on a change in a frequency of the electric signal output from the contact pickup device is provided, and it is particularly preferable that when the frequency exceeds a predetermined value, the control unit stops the output from the amplifying device.

It is preferable that the notification sound generating device is mounted to a body component viewed from around the vehicle and is composed of an oscillator for converting the electric signal output from the amplifying device into mechanical oscillation, and when the oscillator outputs the mechanical oscillation, the body component to which the oscillator is mounted is used as a diaphragm to radiate a notification sound to the periphery of the vehicle.

Further, the contact pickup device is preferably a bone-conduction pickup microphone.

Further, as the vehicle, a hybrid car, an electric automobile, or a fuel-cell automobile is preferable.

According to the presence notification system of the invention, a contact pickup device captures a housing oscillation of an inverter so as to convert it into an electric signal, and the amplifying device amplifies this signal so as to generate a notification sound. For this reason, an inverter sound originally generated from the vehicle notifies surrounding pedestrians of approaching of the vehicle without discomfort, and the inverter generates an oscillation sound also at a time when the vehicle stops at a stoplight, unlike a motor or the like. For this reason, when this sound is amplified, the inverter sound can be used as a notification sound also when standing. Therefore, a reproducing unit for storing/reproducing pseudo-sound data does not have to be provided unlike a conventional system, and a special sound frequency does not have to be modulated, so that the system can be easily post-installed.

Further, the original inverter sound of the vehicle and a notification sound are assimilated into each other, and a driver and a fellow passenger in the vehicle do not feel discomfort at all. Further, when muffling is set at a predetermined or more speed, they seldom feel a change before and after the muffling due to the same inverter sound. Therefore, inconvenience such that the driver and the fellow passenger in the vehicle are conscious of the vehicle speed and thus comfortability is deteriorated.

Further, the control unit for controlling the operation of the amplifying device based on the change in the frequency of the electric signal output from the contact pickup device is provided. For this reason, for example, as the speed increases and thus the frequency is higher, an amplifying amount by means of the amplifying device can be controlled to be smaller, and the output from the amplifying device can be stopped at a predetermined or more frequency based on the frequency of the inverter oscillation that rises due to an increase in the vehicle speed without connecting to a vehicle speed sensor. Installing of the system of the present invention to the vehicle in a care where output of a notification sound is controlled according to the vehicle speed, particularly the post-installing becomes easy, therefore the system can be easily handled.

Further, when the frequency of the electric oscillation output from the contact pickup device, namely, the inverter oscillation frequency exceeds a predetermined value, the control unit controls to stop output from the amplifying device. For this reason, as described above, when the vehicle speed is a certain value or more, a control can be easily made so that the notification sound is eliminated, without connection to the speed sensor.

The notification sound generating unit is mounted to the body component viewed from around the vehicle, and is composed of an oscillator for converting the electric signal output from the amplifying device into mechanical oscillation. When the oscillator outputs the mechanical oscillation, the body component to which the oscillator is mounted is used as a diaphragm to radiate the notification sound to the periphery of the vehicle. For this reason, this unit does not require waterproofing and dust-proofing measures in comparison with a conventional cone-type speaker. As a result, the unit can be easily attached anywhere, and the cost can be reduced.

### BRIEF DESCRIPTION OF THE DRAWINGS

FIG. 1 is an explanatory diagram illustrating a vehicle to which a presence notification system according to a typical embodiment of the present invention is mounted;

FIG. 2 is an explanatory diagram illustrating a state that an oscillation unit is mounted to a bumper of a vehicle;

FIG. 3 is a block diagram illustrating an entire constitution of the presence notification system;

FIG. 4 is a block diagram illustrating a constitution of a notification sound generating device of the presence notification system;

FIG. 5 is a perspective view illustrating the oscillation unit; and

FIG. 6 is a cross-sectional view illustrating a mounting structure of the oscillation unit.

### DESCRIPTION OF THE PREFERRED EMBODIMENTS

An embodiment of the present invention will be described in detail below with reference to accompanying drawings.

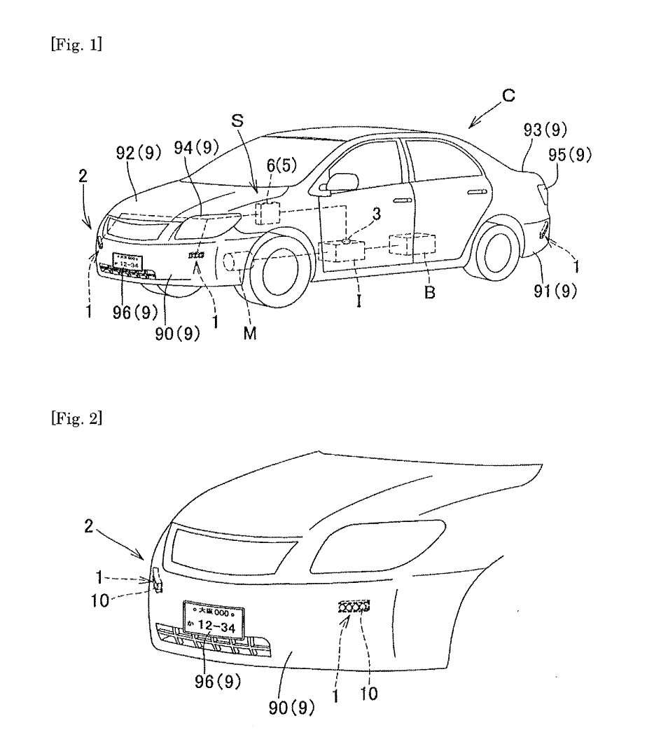

A presence notification system S of the present invention is, as shown in FIG. 1, provided to a vehicle C that has an electric motor M as a power source and uses an inverter I in a driving circuit for driving the electric motor M such as a hybrid car, an electric automobile, or a fuel-cell automobile. The system includes a contact pickup device 3 mounted to a housing of the inverter I for capturing oscillation of the housing so as to convert the oscillation into an electric signal, an amplifying device 5 for amplifying the electric signal output from the contact pickup device 3, and a notification sound generating device 2 for outputting a sound to the periphery of the vehicle based on the electric signal output from the amplifying device 5.

The contact pickup device 3 inputs oscillation caused by contact and converts it into an electric signal so as to output it, and for example, a bone-conduction pickup microphone is suitably used. In the present invention, the housing oscillation of the inverter I is obtained by the contact pickup device 3, and is amplified to be used as a notification sound. For this reason, a sound of the inverter I generated by a vehicle body is used as a presence notification sound, and surrounding pedestrians can be notified of this sound as a natural approaching sound of the vehicle, and thus this sound can be used as a sound natural and comfortable for a driver and a fellow passenger. Therefore, unlike the conventional propose, a reproducing unit for storing/reproducing pseudo-sound data does not have to be provided, and special sound frequency does not have to be modulated, thereby providing a convenient system that can be easily post-installed.

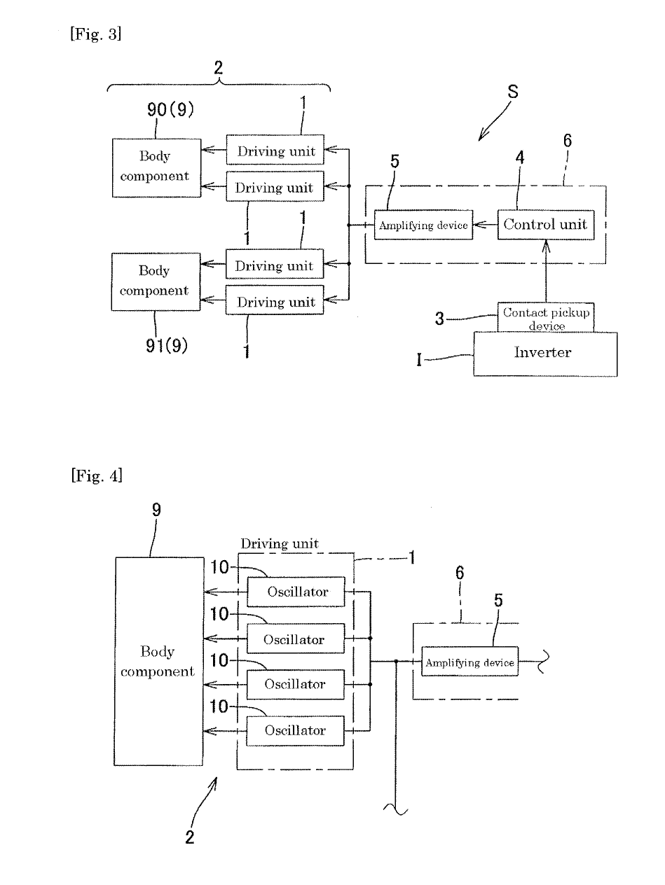

In this example, as shown in FIG. 3, the amplifying device 5 and a control unit 4 composed of a central processing unit (CPU) for controlling an operation of the amplifying device 5 based on a change in a frequency of the electric signal output from the contact pickup device 3 are housed in a control box 6 of the vehicle. An amplifying amount by the amplifying device 5 is set so that about 50 dB can be secured within a range of 2 m forward even in a case of, for example, a low frequency at a low speed. Further, when the frequency exceeds a predetermined value, the control unit 4 preferably stops an output from the amplifying device 5.

The control by means of the control unit 4 is obviously enabled by methods other than the above-described control. For example, a control can be made such that a sound is generated at a low speed not more than a predetermined speed (for example, 20 kilometers per hour) based on a signal from a speed sensor of the vehicle C, or a control can be made so that as the speed increases, an amplifying amount of a reproduced acoustic signal is made smaller. However, when the operation of the amplifying device 5 is controlled based on a value of the frequency as described above, connection with the speed sensor is not necessary, which allows the system to be easily installed, particularly, easily post-installed to the vehicle C, thereby making handling of the device easy.

In the present invention, since the notification sound is generated by amplifying a sound generated from the inverter I obtained by the contact pickup device 3, when the vehicle speed rises, the generated sound heard directly from the inverter I becomes loud, and thus these sounds cannot be discriminated from each other. Therefore, the driver and the fellow passenger are not nervous about the sound, thereby making it unnecessary for the control unit 4 to control to reduce an amplifying amount by means of the amplifier or to stop the output from the amplifier.

The notification sound generating device 2 is, as shown in FIGS. 1 and 2, mounted to a body component 9 viewed from around the vehicle (exposed to the outside), and is composed of an oscillator 10 for converting an electric signal output from the amplifying device 5 into mechanical oscillation. When the oscillator 10 outputs the mechanical oscillation, the body component 9 functions as a diaphragm, and a notification sound is radiated to the periphery of the vehicle. Concretely, also as shown in FIGS. 4 to 6, an oscillation unit 1 is constituted by consecutively installing a plurality of oscillators 10, and the oscillation unit 1 is mounted to the body component 9. The present invention, however, is not limited to that the oscillator 10 oscillates the body component 9 so as to generate a notification sound, and thus various speakers such as a cone type speaker can be employed.

The oscillation unit 1 is preferably provided to inner surfaces of front and rear bumpers 90 and 91 (inner surfaces opposite to outer surfaces (exposed surfaces) viewed from around the vehicle) that are the farthest from the inside of the vehicle from a viewpoint that transmission of a notification sound to the inside of the vehicle can be prevented. This example will be described below. Obviously the oscillation unit 1 can be provided to other body components, such as inner surfaces of an engine hood 92, a trunk 93, a headlight cover 94, a taillight cover 95, and a license plate 96.

As the oscillator 10, for example, a publicly-known bone-conduction diaphragm can be used. In this bone-conduction diaphragm, a voice coil is attached to a central magnetic pole of a yoke, magnets are arranged on ends of short sides on both sides of the yoke, and a diaphragm fixing section is arranged on outsides of the magnets on an axis of the magnet arrangement. This bone-conduction diaphragm outputs an acoustic electric signal received from the amplifying device 5 via a wiring as a mechanical oscillation signal, and transmits it to the body component 9. Besides the oscillator composed of the magnets and the coil, a semiconductor device having a piezo-electric device for causing oscillation can be employed.

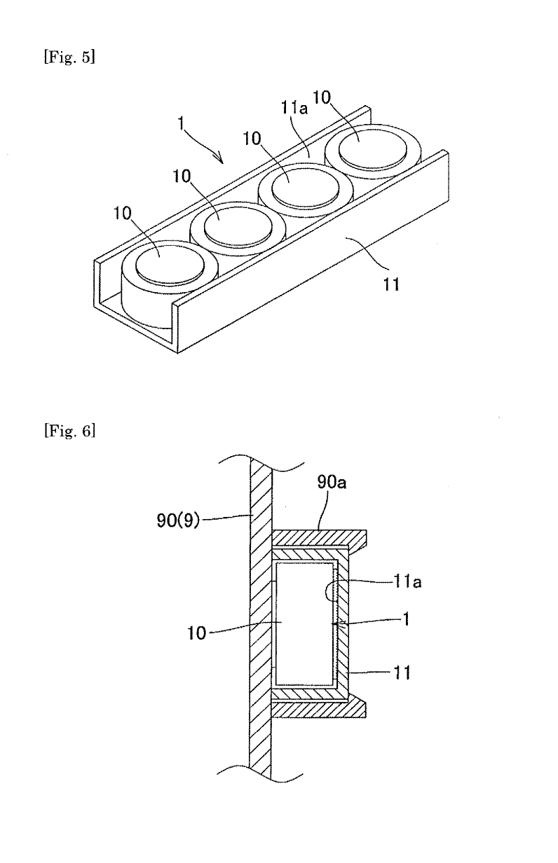

In the oscillation unit 1, as shown in FIG. 5, the plurality of oscillators 10 is consecutively installed, and in this example, the oscillators 10 are arranged to be bonded into the concave groove 11a of a supporting body 11 having a U-shaped cross section. As shown in FIG. 6, the supporting body 11 is locked by a locking piece 90a protruded on the body component 9 so that the oscillators 10 in the concave groove 11a are pressed against the body component 9. Since the plurality of oscillators 10 is consecutively installed in the oscillation unit 1, although the oscillation unit 1 has a compact structure without a cone, it can sufficiently oscillate the body component 9, and can maintain sound volume and sound quality higher than those of a conventional cone type speaker via less electric power. Further, due to presence of the plurality of oscillators, even if one oscillator breaks down due to disconnection of the wiring, the other oscillators can maintain their functions, thereby preventing sudden silencing of an important notification sound.

The oscillation unit 1 is not particularly limited to such a constitution. Further, as to the mounting constitution, various constitutions using attachment screws and adhesive can be employed as long as they enable the oscillators 10 to be in close contact with the body component 9. A mounting constitution may be selected optimally according to types of the body component 9 to be mounted. The number of the oscillators 10 is preferably about 2 to 5 in each oscillation unit 1. Too large number of the oscillators 10 inhibits oscillation. In order to further heighten a waterproof property and dust resistance of the oscillators, the concave groove 11a may be sealed into a water tight state by resin with vibrating surfaces of the oscillators 10 being exposed.

The oscillators 10 in the concave groove 11a are connected in parallel, and receive the acoustic electric signal from the amplifying device 5 so as to perform operations with the same oscillation (amplitudes, frequencies). As a result, even if the parallel wires in the concave groove 11a are disconnected by any cause, the probability that all the oscillators break down is reduced. In this example, the wirings connected in parallel inside are extend to the outside, but the wirings of the oscillators 10 may be extended to the outside so as to be connected in parallel on the outside. Further, the wirings may not be connected in parallel on the outside but may be independent, and an acoustic electric signal may be supplied from the amplifying device 5. The total of four oscillation units 1 are fixed to each of right and left corners of the front and rear bumpers 90 and 91, and oscillate the front and rear bumpers 90 and 91 entirely, so that a notification sound generated by amplifying an inverter housing oscillation sound is radiated to the periphery of the vehicle C.

The embodiment of the present invention is described above, but the present invention is not limited to the embodiment, and it will be obvious that the present invention can be carried out in various forms without departing from the scope of the present invention.

### REFERENCE SIGNS LIST

S Presence notification system
C Vehicle
I Inverter
M Electric motor
1 Oscillation unit
2 Notification sound generating device
3 Contact pickup device
4 Control unit
5 Amplifying device
6 Control box
9 Body component
10 Oscillator
11 Supporting body
11a Concave groove
90, 91 Bumper
90a Locking piece
92 Engine hood
93 Trunk
94 Headlight cover
95 Taillight cover
96 License plate

1. A presence notification system provided to a vehicle having an electric motor as a power source and using an inverter in a driving circuit for driving the electric motor, the system comprising:
a contact pickup device provided to a housing of the inverter, the contact pickup device capturing oscillation of the housing of the inverter generated from oscillation generated from the inverter itself and converting the oscillation into an electric signal;
an amplifying device for amplifying the electric signal output from the contact pickup device; and
a notification sound generating device operably connected to the am device for outputting a sound to a periphery of the vehicle based on the electric signal output from the amplifying device.

2. The presence notification system according to claim 1, further comprising a control unit for controlling an operation of the amplifying device based on a change in a frequency of the electric signal output from the contact pickup device.

3. The presence notification system according to claim 2, wherein when the frequency exceeds a predetermined value, the control unit stops the output from the amplifying device.

4. The presence notification system according to any one of claims 1 to 3, wherein
the notification sound generating device is mounted to a body component viewed from around the vehicle and is composed of an oscillator for converting the electric signal output from the amplifying device into mechanical oscillation, and when the oscillator outputs the mechanical oscillation, the body component to which the oscillator is mounted is used as a diaphragm to radiate a notification sound to the periphery of the vehicle.

5. The presence notification system according to any one of claims 1 to 3, wherein the contact pickup device is a bone-conduction pickup microphone.

6. The presence notification system according to any one of claims 1 to 3, wherein the vehicle is a hybrid car, an electric automobile, or a fuel-cell automobile.
